(19) United States
(12) Patent Application Publication
(10) Pub. No.: US 2008/0096707 A1
(43) Pub. Date: Apr. 24, 2008

(54) Chain tensioner

(75) Inventors: Seiji Sato, Iwata (JP); Tomoyoshi Izutsu, Iwata (JP); Satoshi Kitano, Iwata (JP); Hisashi Hayakawa, Iwata (JP)

Correspondence Address: WENDEROTH, LIND & PONACK, L.L.P., 2033 K STREET N. W., SUITE 800, WASHINGTON, DC, 20006-1021, US

(73) Assignee: NTN CORPORATION, OSAKA JAPAN (JP)

(21) Appl. No.: 10/581,681

(22) PCT Filed: Dec. 20, 2004
(86) PCT No.: PCT/JP04/19026

§ 371 Date: Jun. 6, 2006

(30) Foreign Application Priority Data
Dec. 18, 2003 (JP) 2003-420844

(51) Int. Cl. F16H 7/08

(52) U.S. Cl. 474/111

(57) ABSTRACT

A chain tensioner is provided which can prevent separation of the plunger. In a cylinder chamber 12 of the housing 11, a plunger 13 and a spring 15 that biases the plunger 13 outwardly are mounted. The housing 11 is provided with an oil supply passage 17 communicating with a pressure chamber 16 formed in the cylinder chamber behind the plunger 13. An axially elongated guide recess 31 is formed in the outer periphery of the plunger 13. The housing 11 is provided with a stopper pin 33 near the open end of the cylinder chamber. By abutting the rear end wall 31b of the guide recess 31, the stopper pin 33 prevents separation of the plunger 13 from the housing.

### TECHNICAL FIELD

This invention relates to a chain tensioner for keeping constant tension in a chain such as a camshaft driving chain.

### BACKGROUND ART

Typically, a chain transmission device for driving camshafts includes a chain tensioner for applying regulating force to the slack side of the chain to keep constant tension in the chain.

Among conventional tensioners of this type, there is known one comprising a plunger slidably mounted in a cylinder chamber defined in a housing, and a spring mounted in the cylinder chamber and biasing the plunger outwardly of the cylinder chamber, wherein the housing is formed with an oil supply passage communicating with a pressure chamber formed behind the plunger, whereby the pushing force applied to the plunger is damped by hydraulic oil supplied through the oil supply passage into the pressure chamber.

In such a known chain tensioner, if the engine is stopped with the slack side of the chain tensioned according to the positions of the cams when the engine is stopped, the plunger is sometimes pushed in by the chain and retracts excessively while the engine is at a stop. When the engine is restarted in this state, the chain will significantly slacken, causing the plunger to protrude excessively outwardly. Because the engine has just started, a hydraulic pump cannot sufficiently quickly supply hydraulic oil into the pressure chamber through the oil supply passage, so that air may remain in the pressure chamber. This impairs the damping properties of the tensioner, thus sometimes producing noise.

When the chain and/or chain tensioner is dismounted for maintenance of the valve train of the engine, the plunger, which is being biased by the spring, tends to be pushed out of the cylinder chamber and separate from the housing.

In order to avoid these problems, the chain tensioner disclosed in Patent document 1 is provided with a retraction restrictor means for restricting the retraction of the plunger to prevent the plunger from being pushed into the cylinder chamber more than necessary when the engine has stopped. This tensioner further includes an anti-separation mechanism provided between the housing and the plunger for preventing the plunger from being pushed out of the plunger during maintenance of the valve train of the engine.
Patent document 1: Unexamined Japanese patent publication 2001-355691

### DISCLOSURE OF THE INVENTION

### Problem to Which the Invention Seeks a Solution

In the conventional chain tensioner disclosed in Patent document 1, a ring mounting groove is formed in the inner periphery of the cylinder chamber of the housing near its open end. A register ring is mounted in the ring mounting groove. The register ring also engages in one of a plurality of engaging grooves formed in the outer periphery of the plunger to restrict the retraction of the plunger. The plunger is also formed with a safety groove in its outer periphery near its rear end. When the register ring is engaged in the safety groove, it prevents the plunger from being pushed out of the cylinder chamber. With this arrangement, the register ring is used both to restrict the retraction of the plunger and to prevent the plunger from being pushed out of the cylinder chamber. Thus, to re-set the chain tensioner after maintenance of the valve train of the engine, it was necessary to push the plunger into the cylinder chamber while expanding the register ring by pinching the control portion of the register ring to disengage the register ring from the safety groove.

If an operator forgets to push the plunger into the cylinder chamber, the plunger will be pushed out of the cylinder chamber under the force of the spring, thereby separating from the housing.

An object of this invention is to provide a chain tensioner which includes means for completely preventing separation of the plunger.

### Means to Achieve the Object

According to the invention, there is provided a chain tensioner comprising a housing formed with a cylinder chamber, a plunger slidably mounted in the cylinder chamber, a spring mounted in the cylinder chamber and biasing the plunger outwardly of the cylinder chamber, and a retraction restrictor means provided between the housing and the plunger for preventing the plunger from retracting toward a closed end of the cylinder chamber over a predetermined distance, the housing being formed with an oil supply passage communicating with a pressure chamber defined in the cylinder chamber behind the plunger, whereby pushing force applied to the plunger is dampened by hydraulic oil supplied through the oil supply passage into the pressure chamber, characterized in that an axially elongated guide recess is formed in an outer periphery of the plunger, and that the housing is provided with a stopper pin near an open end of the cylinder chamber, the stopper pin being partially disposed in the guide recess.

The stopper pin may be pressed in a pin hole formed in the housing. The pin hole may be formed to extend radially of the cylinder or across the outer periphery of the cylinder chamber. By using a spring pin as the stopper pin and pressing such a stopper pin into such a pin hole, the stopper pin can be mounted easily and firmly and the deformation of the inner periphery of the cylinder chamber by pressing in the stopper pin can be prevented.

### Advantages of the Invention

With this arrangement, when the chain and/or the chain tensioner according to the invention is dismounted for maintenance of the valve train of the engine, the plunger will move outwardly under the force of the spring. But once the stopper pin abuts the rear end wall of the guide recess, the stopper pin prevents any further advancement of the plunger, thus completely preventing separation of the plunger from the housing.

### BRIEF DESCRIPTION OF THE DRAWINGS

FIG. 1 is a front view of the chain tensioner according to the present invention, as actually used;

FIG. 2 a vertical sectional front view of a chain tensioner according to a first embodiment of the present invention;

FIG. 3 is a sectional view taken along line III-III of FIG. 2;

FIG. 4 is a partial enlarged sectional view of FIG. 2;

FIG. 5 is a vertical sectional front view of a chain tensioner according to a second embodiment of the present invention; and

FIG. 6 is a sectional view taken along line VI-VI of FIG. 5.

### DESCRIPTION OF THE NUMERALS

11 Housing
12 Cylinder chamber
13 Plunger
15 Spring
16 Pressure chamber
17 Oil supply passage
20 Retraction restrictor mechanism
31 Guide recess
31b End wall
32 Pin hole
33 Stopper pin
34 Pin hole
35 Stopper pin

### BEST MODE FOR EMBODYING THE INVENTION

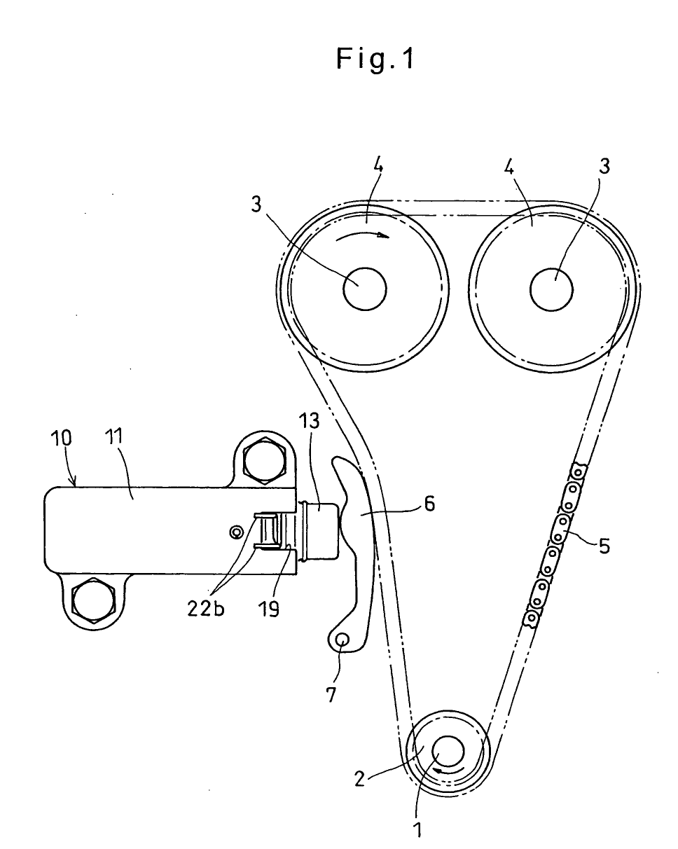

The embodiments of the present invention are now described with reference to the accompanying drawings. FIG. 1 shows a chain transmission device for driving camshafts, which includes a sprocket 2 mounted at one end of a crankshaft 1, sprockets 4 each mounted at one end of one of the camshafts 3, and a chain 5 trained around the sprockets 2 and 4.

A chain guide 6 is in contact with the slack side of the chain 5. The chain guide 6 is pivotable about a pin 7, and is pressed against the chain 5 by a chain tensioner 10 embodying the present invention.

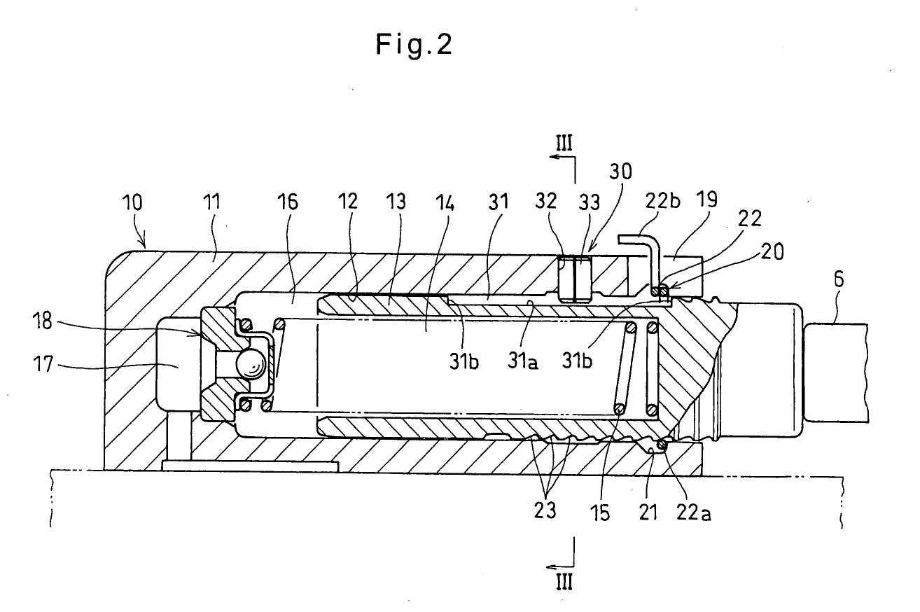

FIGS. 2 to 4 show the chain tensioner according to the first embodiment of the present invention. As shown in FIG. 2, this chain tensioner includes a housing 11 mounted to an engine block and defining a cylinder chamber 12 having a closed end, and a plunger 13 slidably mounted in the cylinder chamber 12.

The plunger 13 has a bore 14 having a rear open end. A spring 15 is mounted between the closed end of the bore 14 and the closed end of the cylinder chamber 12 to bias the plunger 13 outwardly of the cylinder chamber 12.

The housing 11 is formed with an oil supply passage 17 communicating with a pressure chamber 16 defined in the cylinder chamber 12 behind the plunger 13. A check valve 18 is mounted at the oil outlet of the oil supply passage 17. When the pressure of the hydraulic oil in the pressure chamber 16 rises above the supply pressure of the hydraulic oil supplied through the oil supply passage 17, the check valve 18 closes the oil supply passage 17, preventing the flow of hydraulic oil in the pressure chamber 16 into the oil supply passage 17.

Between the housing 11 and the plunger 13, a retraction restrictor mechanism 20 for preventing the plunger 13 from retracting toward the closed end of the cylinder chamber 12 over a predetermined distance is provided.

As shown in FIGS. 2 and 4, the retraction restrictor mechanism 20 comprises a ring mounting groove 21 formed in the inner periphery of the housing 11 near the open end of the cylinder chamber 12, a register ring 22 having a radially elastically deformable ring portion 22a mounted in the ring mounting groove 21, and a plurality of circumferential grooves 23 formed in the outer periphery of the plunger 13 at axially equal intervals. The ring portion 22a of the register ring 22 is adapted to engage in one of the circumferential grooves 23. The circumferential grooves 23 each comprise a tapered surface 23a having its diameter decreasing toward the front end of the plunger 13 and an engaging surface 23b disposed at a small diameter end of the tapered surface 23a.

As shown in FIGS. 1 and 2, the register ring 22 has a pair of control tabs 22b protruding from a window 19 formed in the housing 11 at its open end. By pinching the pair of control tabs 22b, the ring portion 22a can be expanded.

When the plunger 13 advances, the ring portion 22a of the register ring 22 slides rearwardly on the tapered surface 23a and engages into the next circumferential groove 23, thus allowing forward movement of the plunger 13. When the plunger 13 retracts, the ring portion 22a of the register ring 22 is trapped between the rear wall 21a of the ring mounting groove 21 and the engaging surface 23b of the circumferential groove 23, thus restricting the retraction of the plunger 13.

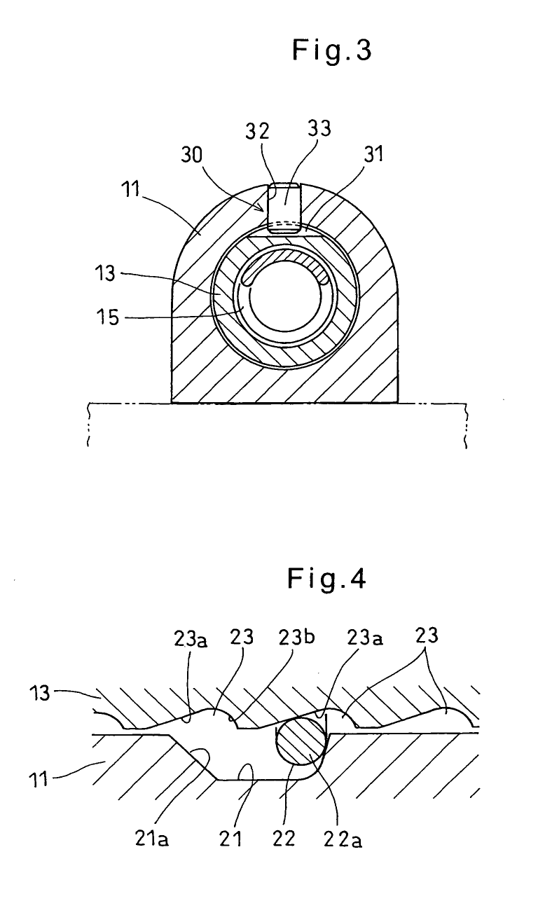

As shown in FIGS. 2 and 3, between the housing 11 and the plunger 13, an anti-separation mechanism 30 is provided to prevent any further advancement of the plunger 13 after the plunger 13 has advanced by a predetermined stroke, thereby preventing separation of the plunger 13 from the housing 11.

The anti-separation mechanism 30 comprises an axially elongated guide recess 31 formed in the outer periphery of the plunger 13 and having front and rear end walls 31b, a radial pin hole 32 formed in the housing 11 near the open end of the cylinder chamber 12, and a stopper pin 33 in the form of a spring pin pressed into the pin hole 32 and having its radially inner end protruding into the guide recess 31. By abutting the rear end wall 31b of the recess 31, the stopper pin 33 prevents the plunger 13 from being pushed out of the cylinder chamber 12.

In this embodiment, the guide recess 31 consists of a flat surface 31a extending axially of the plunger 13 and the pair of end walls 31b. But the guide recess may be a groove instead.

The spring pin as the stopper pin 33 elastically and diametrically shrinks when pressed into the pin hole 32. Therefore, even if the housing 11 is made of aluminum alloy, it is possible to prevent deformation of the inner peripheral surface of the cylinder chamber 12, so that the gap between the inner peripheral surface of the cylinder chamber and the outer peripheral surface of the plunger 13 remains constant. This ensures smooth sliding of the plunger 13.

The chain tensioner 10 of the first embodiment has its housing 11 mounted to an engine block such that the chain guide 6 shown in FIG. 1 is pressed by the plunger 13, which is biased outwardly of the cylinder chamber by the spring 15.

With the chain tensioner 10 mounted in such a manner, when the chain 5 vibrates and slackens due to changes in the angular velocity of the crankshaft 1 when the crankshaft 1 rotates once or due to changes in torque applied to the camshafts 3, the plunger 13 moves outwardly under the force of the spring 15, thus re-tensioning the chain 5.

When the plunger 13 advances, the ring portion 22a of the register ring 22 expands, pushed by the tapered surface 23a of the circumferential groove 23, thus allowing the plunger 13 to advance. When the amount of movement of the plunger 13 exceeds the pitch of the circumferential grooves 23, the ring portion 22a of the register ring 22 engages in the next rearward circumferential groove 23.

When the tension in the chain 5 increases, pushing force is applied from the chain to the plunger 13 through the chain guide 6. Hydraulic oil in the pressure chamber 16 dampens such pushing force.

If the engine is stopped with the slack side of the chain 5 tensioned according to the positions of the cams on the camshafts 3 when the engine is stopped, the plunger 13 is pushed by the chain 5. But in this state, because the ring portion 22a of the register ring 22 is trapped between the rear wall 21a of the ring mounting groove 21 and the engaging surface 23b of one of the circumferential grooves 23, the plunger 13 is prevented from retracting any further. This in turn prevents flapping of the chain 5 when the engine is restarted.

When the chain 5 and/or the chain tensioner 10 is dismounted for maintenance of the valve train of the engine, the plunger 13 advances under the force of the spring 15. But the stopper pin 33 prevents separation of the plunger 13 by abutting the rear end wall 31b of the guide recess 31.

To re-set the chain tensioner after maintenance, the plunger 13 is pushed in while expanding the ring portion 22a of the register ring 22 by pinching the pair of the control tabs 22b of the register ring 22.

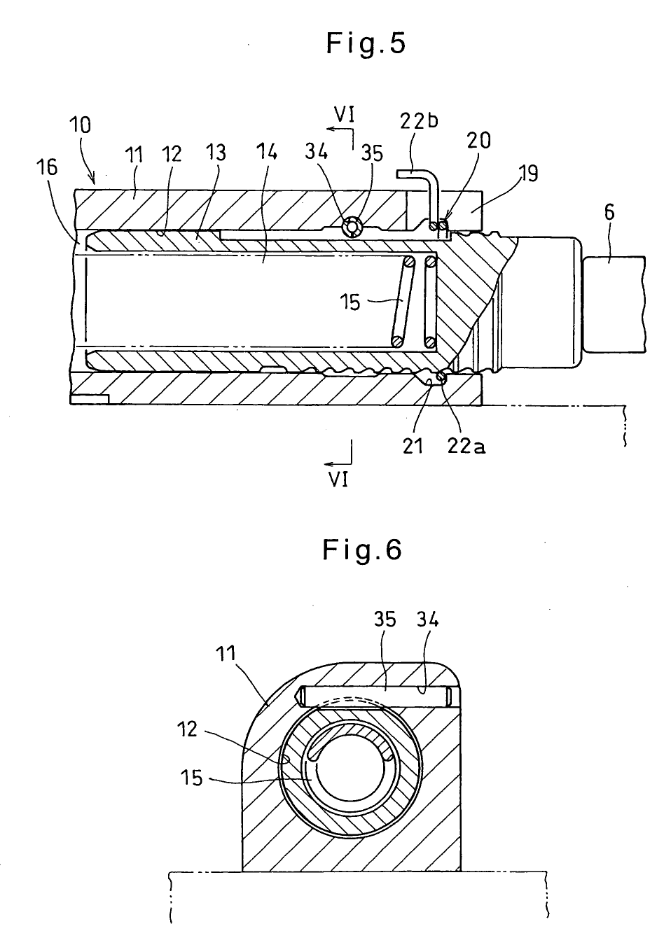

FIGS. 5 and 6 show the chain tensioner according to the second embodiment of the present invention. In this embodiment, a pin hole 34 is formed in the housing 11 across the outer periphery of the cylinder chamber 12 near the open end of the cylinder chamber. A stopper pin 35 comprising a spring pin is pressed into the pin hole 34 so as to be partially disposed in the guide recess 31. By abutting the rear end wall 31b of the guide recess 31, the stopper pin 35 prevents separation of the plunger 13 from the housing 11.

Because the second embodiment is otherwise the same as the first embodiment, like elements are denoted by like numerals and their description is omitted.

By providing the housing 11 with the pin hole 34 so as to extend across the outer periphery of the cylinder chamber 12 and pressing the stopper pin 35 into the pin hole 34, it is possible to effectively prevent deformation of the inner peripheral surface of the cylinder chamber 12.

1. A chain tensioner comprising a housing formed with a cylinder chamber, a plunger slidably mounted in said cylinder chamber, a spring mounted in said cylinder chamber and biasing said plunger outwardly of said cylinder chamber, and a retraction restrictor means provided between said housing and said plunger for preventing said plunger from retracting toward a closed end of said cylinder chamber over a predetermined distance, said housing being formed with an oil supply passage communicating with a pressure chamber defined in said cylinder chamber behind said plunger, whereby pushing force applied to said plunger is dampened by hydraulic oil supplied through said oil supply passage into said pressure chamber, characterized in that an axially elongated guide recess is formed in an outer periphery of said plunger, and that said housing is provided with a stopper pin near an open end of said cylinder chamber, said stopper pin being partially disposed in said guide recess.

2. The chain tensioner of claim 1 wherein said housing is formed with a pin hole extending radially of said cylinder chamber near said open end of said cylinder chamber, said stopper pin being pressed in said pin hole.

3. The chain tensioner of claim 1 wherein said housing is formed with a pin hole extending across the outer periphery of said cylinder chamber near said open end of said cylinder chamber, said stopper pin being pressed in said pin hole.

4. The chain tensioner of claim 1 wherein said stopper pin is a spring pin.

5. The chain tensioner of claim 2 wherein said stopper pin is a spring pen.

6. The chain tensioner of claim 3 wherein said stopper pin is a spring pen.
